(19) United States
(12) Patent Application Publication
(10) Pub. No.: US 2006/0103634 A1
(43) Pub. Date: May 18, 2006

(54) Apparatus and method of providing fingertip haptics of visual information using electro-active polymer for image display device

(75) Inventors: Yoon Sang Kim, Seongnam-si (KR); Byung Seok Soh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/229,609

(22) Filed: Sep. 20, 2005

(30) Foreign Application Priority Data
Nov. 17, 2004 (KR) 10-2004-0094209

(51) Int. Cl. G09G 5/00

(52) U.S. Cl. 345/173

(57) ABSTRACT

An apparatus provides fingertip haptics of visual information using an electro-active polymer for an image display device. The apparatus includes a sensing unit which outputs a detecting signal by detecting a user's finger touching a surface of a touch panel; a pattern generating unit which generates a pattern signal of haptic information from the visual information based on the detecting signal, and a control unit which moves the electro-active polymer based on the detecting signal from the sensing unit and deforms the electro-active polymer based on the pattern signal from the pattern generating unit.

### BACKGROUND OF THE INVENTION

This application claims priority from Korean Patent Application No. 10-2004-0094209 filed on Nov. 17, 2004, in the Korean Intellectual Property Office, the disclosure of which is incorporated herein in its entirety by reference.

1. Field of the Invention

Apparatuses and methods consistent with the present invention relate providing fingertip haptics of visual information, and more particularly, to providing fingertip haptics of visual information using an electro-active polymer for an image display device.

2. Description of the Related Art

Haptic is a sense of fingertip touch that people feel when touching an object. The haptic includes tactile feedback that can be felt when a person's skin contacts a surface of the object and a kinesthetic force feedback (hereinafter referred to as “force feedback”) that can be felt when a movement of a joint and a muscle is disturbed.

The study of transmitting haptic information using a physical device without touching the object by a person has been widely developed. Particularly, a study on teleoperation for transmitting physical properties of a remote object to the person has been developed. A haptic interface for bi-directional information flow functions to input information on a movement or current location of an operator to a virtual environment or a remote working object and to transmit information on force or sense of touch generated from the virtual environment or the remote working object to the operator. At this point, a media object that can bi-directionally transmit, a sense of touch, a property, a shape and the like of an object to perform a haptic interface in a virtual environment or a remote working object using a haptic sense without actually touching and operating the working object using fingers is required. Such a media object is called a haptic device. Accordingly, an ideal haptic device is one that can perfectly provide a state where a person feels naturally and actually a virtual object or a remote object as if he/she were actually touching and operating the object. That is, in order to perform the ideal haptic interface, the haptic device should be designed to reproduce a movement property with responsiveness as if the person were actually touching the remote object. Most of the studies on the haptic device have been developed to realize the force feedback through a mechanical operation of a motor and a control of the motor. In order to improve the performance of the haptic interface to increase a degree of freedom for realizing the reproduction of the movement, the connecting mechanism of the mechanical links becomes complicated, increasing the weight of the device to cause an inertia problem. Accordingly, a passive haptic device using magnetorheological fluid has been developed to reduce the weight and size of the device.

According to the prior art, a haptic feedback device for providing visual information, such as a button and an icon displayed on a display part of an image display device, to which haptic information is added, includes an interface unit that is mechanically controlled and one or more actuators for driving the interface unit. As mechanically driven actuators are added to the device, the size of the device is increased to be limited in its application or operation. Additionally, in order to accurately transmit the haptic information, the number of actuators must be increased, thereby making the structure of the device more complicated.

### SUMMARY OF THE INVENTION

The present invention provides an apparatus and method of providing fingertip haptics of visual information using an electro-active polymer, which can allow a user to feel a texture of a surface of an object and a sense of touch of the object by providing force feedback and tactile feedback by moving and deforming the polymer inserted in a touch panel of an image display device.

According to an aspect of the present invention, there is provided an apparatus of providing fingertip haptics of visual information using an electro-active polymer for an image display device, the apparatus comprising a sensing unit which outputs a detecting signal by detecting a user's finger touch on a touch panel; a pattern generating unit which generates a pattern signal of haptic information from the visual information based on the detecting signal; and a control unit which moves the electro-active polymer based on the detecting signal from the sensing unit and deforms the electro-active polymer based on the pattern signal.

According to another aspect of the present invention there is provided a method of providing fingertip haptics of visual information using an electro-active polymer for an image display device, the method comprising outputting a detecting signal of a user's finger touch on a touch panel; moving the electro-active polymer to a touch point by applying a first driving voltage based on the detecting signal; generating a pattern signal of haptic information from the visual information based on the detecting signal; and deforming the electro-active polymer by applying a second driving voltage based on the pattern signal.

According to still another aspect of the present invention, a recording medium stores a program that can perform a method of providing fingertip haptics of visual information using an electro-active polymer for an image display device, the method comprising outputting a detecting signal of a user's finger touch on a touch panel; moving the electro-active polymer to a touch point by applying a first driving voltage based on the detecting signal; generating a pattern signal of haptic information from the visual information based on the detecting signal; and deforming the electro-active polymer by applying a second driving voltage based on the pattern signal.

### BRIEF DESCRIPTION OF THE DRAWINGS

The above and other aspects of the present invention will become more apparent by describing in detail exemplary embodiments thereof with reference to the attached drawings in which:

FIG. 1 is a schematic block diagram of a device for providing fingertip haptics of visual information, according to an exemplary embodiment of the present invention;

FIG. 2A is a schematic side view of a touch panel of an image display device in which a polymer is inserted;

FIG. 2B is a view illustrating expansion/contraction of a single electro-active polymer by an electrical activation;

FIG. 2C is a view illustrating vertical movement of electro-active polymers by an electrical activation;

FIG. 3 is a flowchart of a method of providing fingertip haptics of visual information using an electro-active polymer, according to an exemplary embodiment of the present invention;

FIG. 4 is a flowchart illustrating a polymer movement operation of S320 depicted in FIG. 3; and

FIG. 5 is a flowchart illustrating a polymer deforming operation of S340 and a pattern generating operation of S330, which are illustrated in FIG. 3.

### DETAILED DESCRIPTION OF THE EXEMPLARY EMBODIMENTS OF THE PRESENT INVENTION

Exemplary embodiments of the present invention will be described more in detail hereinafter with reference to the accompanying drawings.

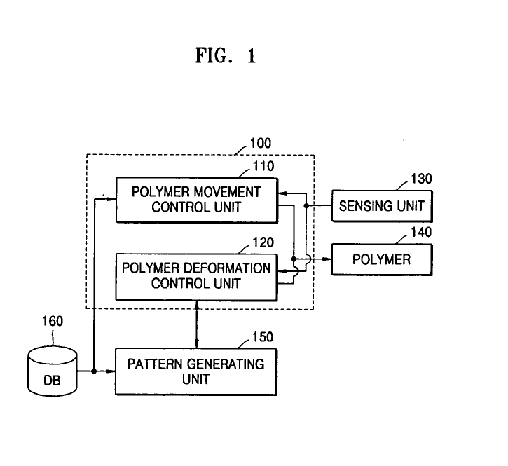

FIG. 1 shows a schematic block diagram of a device for providing fingertip haptics of visual information, according to an exemplary embodiment of the present invention.

The inventive device includes a control unit 100, a sensing unit 130, an electro-active polymer (hereinafter referred to as “polymer”) 140, a pattern generating unit 150, and a database 160.

The control unit 100 is designed to move the polymer 140 based on a detecting signal from the sensing unit 130 and deform the polymer 140 based on a pattern signal generated from visual information. The control unit 100 is comprised of a polymer movement control unit 110 and a polymer deformation control unit 120. The polymer movement control unit 110 moves a contacting point by applying a first driving voltage to the polymer 140 based on location information of the touch point of the detecting signal. The polymer deformation control unit 120 expands and contracts the polymer by applying a second driving voltage to the polymer 140 based on the pattern signal from the pattern generating unit 150.

The sensing unit 130 outputs the detecting signal to the control unit 100 by detecting the user's finger contact on the touch panel.

The pattern generating unit 150 outputs the pattern signal to the control unit 100 by generating a pattern of haptic information from the visual information based on the detecting signal. In FIG. 1, the pattern generating unit 150 is formed to be independent from the control unit 100; however, it can be formed with the control unit 100 in a single chip.

The polymer 140 is moved or deformed by being electrically activated under the control of the control unit 100, thereby providing the fingertip haptics of the visual information to the user. That is, when the polymer 140 is activated by a driving voltage (or a driving current), it may be physically moved or deformed. The polymer 140 may be selected from the group consisting of gel, an ionic polymer, a conducting polymer, and an electro-restrictive polymer. However, the present invention is not limited to these polymers.

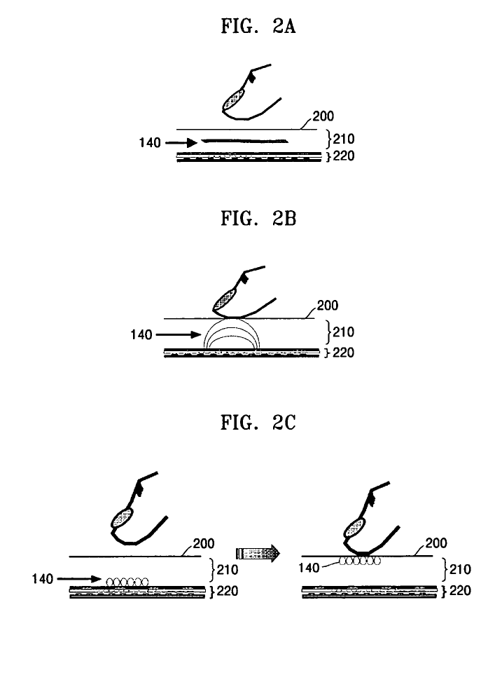

The polymer 140 may be formed of a single electro-active polymer or a plurality of electro-active polymers. If using a plurality of electro-active polymers, it is possible to more accurately transmit the haptics to the user, but the manufacturing cost is increased. FIGS. 2B and 2C show exemplary embodiments using a single electro-active polymer and a plurality of electro-active polymers, respectively.

FIG. 2A shows a schematic side view of a touch panel of an image display device in which a polymer is inserted. The touch panel includes an indium tin oxide (ITO) layer 200, a spacer 210 and a panel unit 220. FIG. 2B illustrates expansion/contraction of a single electro-active polymer by an electrical activation. FIG. 2C illustrates a vertical movement of a plurality of electro-active polymers by an electrical activation.

Referring again to FIG. 1, the database 160 stores visual information including haptic information. The visual information stored in the database 160 includes geometric information (e.g., a width, a length, a height, etc.) and physical information (e.g., a friction coefficient, an elastic coefficient, a mass, etc.) of an object such as a button, an icon and the like that are displayed on the panel unit 220. Such visual information may be actual information obtained based on actual data (e.g., from Computerized Axial Tomography (CT) or Magnetic Resonance Imaging (MRI) visual information data) or may be artificial information generated by a predetermined pattern.

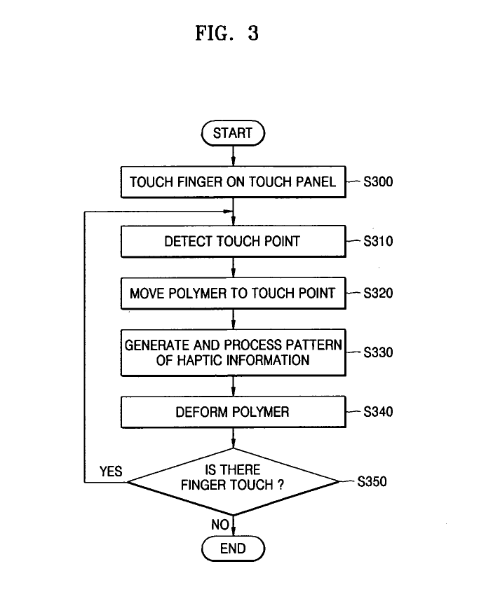

FIG. 3 shows a method of providing fingertip haptics of visual information using an electro-active polymer, according to an exemplary embodiment of the present invention.

The method illustrated in FIG. 3 will be described hereinafter in conjunction with FIGS. 1 and 2.

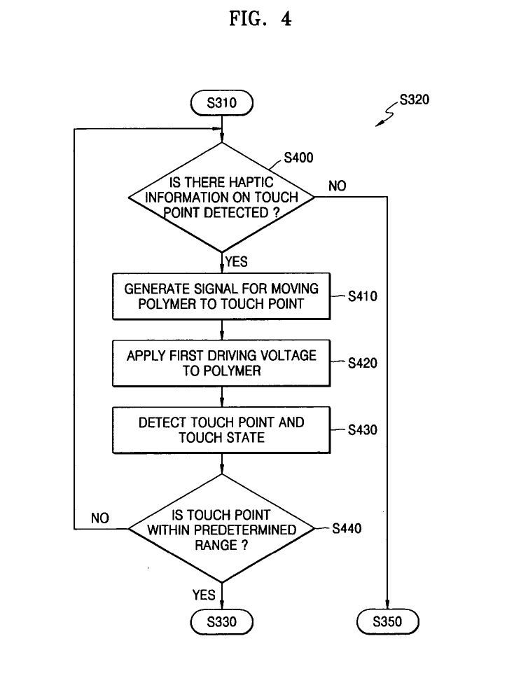

Referring to FIGS. 1 through 3, In S300, the user touches the ITO layer 200 of the touch panel. In S310, the sensing unit 130 detects a touch point (i.e., a point of contact) of the user's finger on the touch panel. Here, the touch point is not necessarily limited to a single point where the user's finger touches the touch panel. That is, the touch point may include, for example, a line or a surface. At this point, the sensing unit 130 detects a touch state (i.e., touch pressure) as well as the touch point and transmits this information in a detecting signal to the control unit 100. In S320, the polymer movement control unit 110 moves the polymer 140 to the touch point by applying a first driving voltage to the polymer 140 based on location information of the touch point in the detecting signal. In the case of the single electro-active polymer, the polymer moves only in a horizontal direction. However, in the case of the plurality of electro-active polymers, the polymer moves in both the horizontal and vertical directions. The operation S320 will be described more in detail with reference to FIG. 4.

In S330, the pattern generating unit 150 generates a pattern of the haptic information from the visual information based on the detecting signal and transmits the pattern signal to the control unit 100. In S340, the polymer deformation control unit 120 contracts or expands the polymer 140 by applying a second driving voltage to the polymer 140 based on the pattern signal from the pattern generating unit 150. In S350, it is determined if there is a finger touching the touch panel. If there is a finger touching the touch panel, in S310, the sensing unit 130 detects the touch point and the touch state and outputs the detecting signal to the control unit 100. If there is no finger touching the touch panel, the process is ended.

FIG. 4 is a flowchart illustrating a polymer movement operation of S320 depicted in FIG. 3. The operation will be described in more detail in conjunction with FIG. 1.

Referring to FIGS. 1 and 4, in S400, it is determined if there is haptic information on the detected touch point. If there is no haptic information on the touch point, the process goes to S350. If there is haptic information on the touch point, the process goes to S410. In S410, a signal for moving the polymer to the touch point is generated. In S420, the first driving voltage (or current) is applied to the polymer 140 according to the signal generated to move the polymer to the touch point. Here, the driving voltage being applied may be, for example, 0 to 1 kV. If the current is applied, the current may be, for example, less than several mA. At this point, the polymer 140 is moved only when the driving voltage is greater than a first critical valve. The higher the driving voltage, the greater the moving speed of the polymer 140. In the case of the single electro-active polymer, the polymer is moved in the horizontal direction by the driving voltage higher than the first critical value. In the case of the plurality of electro-active polymers, the polymers are moved in both the horizontal and vertical directions by the driving voltage higher than the first critical value. As shown in FIG. 2C, if the driving voltage is higher than a second critical value greater than the first critical valve, the polymer is moved only in the vertical direction.

In S430, the sensing unit 130 detects the touch point and the touch state of the user's finger with respect to the touch panel. In S440, a distance from the former touch point to the currently detected touch point is calculated and it is determined if the calculated distance is within a predetermined range. If the distance is not within the predetermined range, the process is returned to S400 to perform the polymer movement operation. If the distance is within the predetermined range, the process goes to S330 to perform the polymer deformation operation.

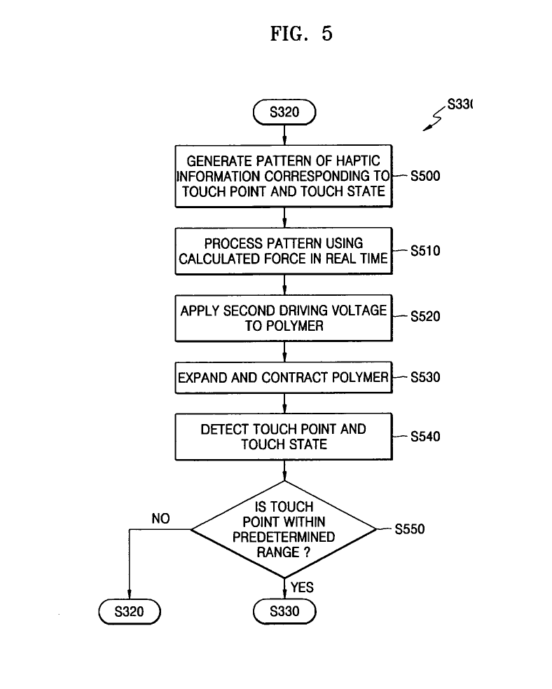

FIG. 5 shows a flowchart illustrating a polymer deforming operation of S340 and a pattern generating operation of S330, which are illustrated in FIG. 3. This operation will be described hereinafter in conjunction with FIGS. 1 and 3.

Referring to FIGS. 1 and 5, in S500, the pattern generating unit generates a pattern of the haptic information corresponding to the touch state and the touch point from the visual information stored in the database 160 based on the detecting signal from the sensing unit 130. Using the geometry and physical information of the object stored in the database 160, a predetermined (or calculated) pattern is generated. The pattern may be generated based on artificial computing or actual data. For example, the pattern may be generated based on a polygon or finite element method (FEM).

In S510, the haptic information pattern is processed based on force (or speed, location, etc.) calculated in real time. At this point, even if the pattern of the haptic information is identical, if the force (or speed, location, etc.) is different, the pattern of the haptic information may have a different value. Such a patterning process of the haptic information is called haptic rendering. The patterning process of the haptic information is performed through, for example, a point-based method regarding the touch point as a single point or a multipoint-base method (or a surface-based method) regarding the touch point as multiple points.

In S520, the polymer deformation control unit 120 applies the second driving voltage (or current) to the polymer 140 according to the haptic information pattern from the pattern generating unit 150. Here, the driving voltage being applied may be, for example, 0 to 1 kV. If the current is applied, the current may be, for example, less than several mA. In S530, the polymer 140 contracts or expands according to the applied second driving voltage. At this point, the expansion and contraction may be varied according to the value of the second driving voltage.

In S540, the sensing unit 130 detects the touch point and the touch state of the user's finger with respect to the touch panel. In S550, a distance from the former touch point to the currently detected touch point is calculated and it is determined if the calculated distance is within a predetermined range. If the distance is not within the predetermined range, the process is returned to S320 to perform the polymer movement operation. If the distance is within the predetermined range, the process goes to S330 to perform the pattern generating operation.

In another exemplary embodiment, the present invention may be realized as code that can be read by a computer. The code may be recorded in recording media that can be read by the computer. The recording media readable by the computer can be any recording device in which data is stored and can be read by the computer system, such as a ROM, a RAM, a CD-ROM, a magnetic tape, a floppy disk, an optical data storage, etc. Exemplary embodiments of the present invention may also be realized by a carrier wave (e.g., a transmission through the Internet).

According to the exemplary embodiments of the present invention, a user can feel a texture of a surface of an object and a sense of touch of the object by receiving force feedback and tactile feedback provided by moving and deforming a polymer inserted in a touch panel of an image display device. Additionally, by providing haptic information to the visual information such as a menu and an icon that are displayed on the touch panel, the user can easily operate the computer and input errors may be remarkably reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus providing fingertip haptics of visual information using electro-active polymer for an image display device, the apparatus comprising:
a sensing unit which outputs a detecting signal by detecting a user's finger contacting a touch panel;
a pattern generating unit which generates a pattern signal of haptic information from the visual information based on the detecting signal; and
a control unit which moves the electro-active polymer based on the detecting signal from the sensing unit and deforms the electro-active polymer based on the pattern signal from the pattern generating unit.

2. The apparatus of claim 1, wherein the electro-active polymer is formed of a single electro-active polymer.

3. The apparatus of claim 2, wherein the control unit comprises:
a polymer movement control unit which moves the single electro-active polymer to a point of contact of the user's finger on the touch panel by applying a first driving voltage or current to the single electro-active polymer based on location information of the point of contact in the detecting signal; and
a polymer deformation control unit which expands and contracts the single electro-active polymer by applying a second driving voltage or current to the single electro-active polymer based on the pattern signal from the pattern generating unit.

4. The apparatus of claim 1, wherein the electro-active polymer is formed of a plurality of electro-active polymers.

5. The apparatus of claim 4, wherein the control unit comprises:
a polymer movement control unit which horizontally moves the plurality of electro-active polymers to a point of contact of the user's finger on the touch panel, and activates the plurality of electro-active polymers by moving the plurality of electro-active polymers in a vertical direction by applying a first driving voltage or current to the plurality of electro-active polymers based on location information of the point of contact in the detecting signal; and
a polymer deformation control unit which expands and contracts the plurality of electro-active polymers by applying a second driving voltage or current to the plurality of electro-active polymers based on the pattern signal from the pattern generating unit.

6. The apparatus of claim 1, further comprising a database storing the visual information including the haptic information.

7. A method of providing fingertip haptics of visual information using an electro-active polymer for an image display device, the method comprising:
outputting a detecting signal of a user's finger contacting a touch panel;
moving the electro-active polymer to a first point of contact of the user's finger on the touch panel by applying a first driving voltage or current based on the detecting signal;
generating a pattern signal of haptic information from the visual information based on the detecting signal; and
deforming the electro-active polymer by applying a second driving voltage or current based on the pattern signal.

8. The method of claim 7, wherein the moving the electro-active polymer comprises:
determining if the visual information has the haptic information on the first point of contact; and
generating a moving signal for moving the electro-active polymer to the first point of contact, if the visual information has the haptic information on the first point of contact.

9. The method of claim 7, wherein the moving the electro-active polymer comprises:
detecting a second point of contact and a first touch state of the user's finger on the touch panel, after applying the first driving voltage or current to the electro-active polymer; and
calculating a first distance from the first point of contact to the second point of contact; and
moving the electro-active polymer to the second point of contact by applying the first driving voltage or current, if the first distance is within a predetermined range.

10. The method of claim 9, wherein the generating the pattern signal comprises generating a pattern of the haptic information corresponding to the second point of contact and the touch state from the visual information based on the detected signal.

11. The method of claim 10, wherein the generating the pattern signal further comprises processing the pattern of the haptic information based on a force calculated in a real time.

12. The method of claim 9, wherein the moving the electro-active polymer comprises:
detecting a third point of contact and a second touch state of the user's finger on the touch panel, after applying the second driving voltage or current to the electro-active polymer;
calculating a second distance from the second point of contact to the third point of contact; and
moving the electro-active polymer to the third point of contact by applying the first driving voltage or current, if the second distance is not within the predetermined range, and generating the pattern signal if the second distance is within the predetermined range.

13. The method of claim 7, wherein the electro-active polymer is formed of a single electro-active polymer.

14. The method of claim 7, wherein the electro-active polymer is formed of a plurality of electro-active polymers.

15. The method of claim 14, wherein the moving the electro-active polymer comprises horizontally moving the plurality of electro-active polymers to the first point of contact and activating the plurality of electro-active polymers by moving the plurality of electro-active polymers in a vertical direction by applying the first driving voltage or current to the plurality of electro-active polymers based on location information of the first point of contact in the detecting signal.

16. A recording medium storing a program for performing a method of providing fingertip haptics of visual information using an electro-active polymer for an image display device, the method comprising:
outputting a detecting signal of a user's finger contacting a touch panel;
moving the electro-active polymer to a point of contact of the user's finger on the touch panel by applying a first driving voltage or current based on the detecting signal;
generating a pattern signal of haptic information from the visual information based on the detecting signal; and
deforming the electro-active polymer by applying a second driving voltage or current based on the pattern signal.
